(19) United States
(12) Patent Application Publication
(10) Pub. No.: US 2019/0172070 A1
(43) Pub. Date: Jun. 6, 2019

(54) SYSTEM FOR CREATING SAFETY DATA SHEETS

(71) Applicant: GLOBAL SAFETY MANAGEMENT, INC., Wesley Chapel, FL (US)

(72) Inventors: Julia MacGregor, Wesley Chapel, FL (US); James MacGregor, Wesley Chapel, FL (US); Daniel Cremens, Wesley Chapel, FL (US)

(21) Appl. No.: 15/536,821

(22) PCT Filed: Feb. 3, 2017
(86) PCT No.: PCT/US2017/016545

§ 371 Date: Jun. 16, 2017

Related U.S. Application Data
(60) Provisional application No. 62/291,343, filed on Feb. 4, 2016.

(51) Int. Cl. G06Q 30/00; G06Q 50/26; G06F 16/93

(52) U.S. Cl. CPC G06Q 30/018; G06F 16/93; G06Q 50/265

(57) ABSTRACT

A safety data sheet management system comprises a computer, storage media and a database, the database containing data on component substances and information related to reactions between the component substance. From these component substances, a set of physical masters is created and a set of health masters is created. For example, these masters are combined together and combined with component masters to automatically generate safety data sheets.

### CROSS RELATED APPLICATIONS

This application is a 371 U.S. national phase of International Application of PCT/US2017/016545 filed Feb. 3, 2017 which claims the benefit of the filing date of U.S. Provisional Application 62/291,343, which was filed on Feb. 4, 2016, the disclosure of which is hereby incorporated by reference in its entirety.

### FIELD OF THE INVENTION

The field relates to the management, creation, distribution and control of safety data sheets, labels and related safety documents.

### BACKGROUND

Safety data sheets are required to be produced by regulations intended to improve safety by having information necessary for companies and their employees to understand the safety of materials purchased and used in production of products and services. Initially, the information required to be maintained was limited in nature, but regulations have been promulgated over time until maintaining safety data sheets has become a complex and difficult task.

A material safety data sheet is a required document that contains information for the safe handling, use, storage and disposal of potentially hazardous chemicals. The United Nations, OSHA, EPA, EU and Health Canada and other government entities all require producers, buyers and users of potentially hazardous substances to maintain and provide specific information related to those substances to ensure the safety of all personnel that are involved in manufacturing, distributing, transporting and using these materials in their day-to-day operations.

The Federal Emergency Management Agency (FEMA) estimates that there are 4.5 million facilities in the United States that handle chemical materials, which require safety data sheets (previously Material Safety Data Sheets or MSDS). According to OSHA's CFR 1910.1200, manufacturers and distributors are required to deliver a safety data sheet (SDS) to each buyer of these materials. In turn, buyers, or employers, are required to make this information readily accessible to their employees who may come in contact with chemicals in the workplace. There are more than 100 million possible components that could be included on safety data sheets, and the list of these substances continues to grow. These components are combined into an infinite variety of safety data sheets. A database of properties for over 100 million possible components, where components means a material, such as a physical, chemical or biological substance, is used by some safety data sheet services. By selecting from these 100 million components, an infinite variety of unique safety data sheet documents may be generated for their customers, but each document is unique and must be tracked, burdening the already burdened compliance and safety professionals. In this way, a company's safety data sheets can be compliant with the letter of the regulations governing safety data, but the spirit of the regulation, which is to have useful safety data readily available and up to date, is becoming harder and harder to ensure.

Prior to the Internet and corporate intranets, safety data sheet management consisted of libraries containing large three-ring binders of paper forms. Even without the growth in regulations, this paper-based system of creating and storing paper-based safety data sheets was costly, cumbersome, and noncompliant. Noncompliance costs millions in fines, penalties and expenses, annually.

Other online systems are know that reproduce paper-based systems using the automation, storage and editing of safety data sheets available with computerization. So, computerized management systems made maintenance less costly, less cumbersome and reduced noncompliance, due to improved access, management and employee “Right-to-Know” compliance using a database reflecting a system equivalent to the paper-based solution and binders. Third party databases are accessible online for a fee, and the third party provider gives access to their databases for a fee. These databases contain millions of indexed, manufacturer-original documents. In one example, a third party provider adds up to 10,000 new and/or updated safety data sheets every week! Applicant's inventions do not merely automate an overwhelmed manual system. Instead, Applicant's system transforms an impossible manual or automated system into a structured, manageable collection that can be tailored to specific customers to simplify creation and distribution of safety data sheets, regardless of the national or international laws, statutes, regulations or guidelines. Applicant's system fundamentally transforms the system of safety data sheet creation and distribution by avoiding the impossibly complex and ultimately futile effort to generate safety data sheets from a database of 100 million components.

To understand the futility of the way that this has been done, consider that these existing third party databases, based on 100 million components and growing, need to be combined with inventory management systems, automating the process of management, somewhat, while again increasing the complexity of the overall system. However, safety data sheets must still be created from the component database and locating a data sheet among the mountain of data sheets is completed by searching through the mountain of data sheets that have been created, previously, to find the one that you need, merely automating a process that would have been done using paper-based systems. In paper-based systems, the safety data sheet would be found by providing indexing. Known automated systems provide indexing or text searching of databases of created and stored safety data sheets. It is known for management solutions to merely combine access to a database with inventory management and data sheet deployment tools.

As companies create new formulations and products, the number of safety documents grows, sometimes exponentially. Companies often create new trade names, product numbers or SKU (stock keeping units) for existing products, with or without changes to the product, itself. As more identifiable “products” are created (formulated), purchased, stored and sold, a company is required to create, store, distribute and manage more safety documents. Ultimately, the burden of keeping these documents and keeping them up to date and accessible can become overwhelming, even using modern databases and computerized storage and retrieval solutions.

Some companies have dealt with this burden by adding all of the related trade names or numbers to a single safety data sheet. Unfortunately, this can result in a long, complex safety data sheet with page(s) of product names/numbers. This goes against the spirit and purpose of safety data sheets, which is to provide easy access to important product and safety information on products that you manufacture, purchase, sell or distribute. This practice makes it difficult to quickly review a safety data sheet and even more difficult to use paper copies of data sheets, which become longer, with additional costs for printing. Instead, safety data sheets are made accessible on a computer, by someone who has access to the computer by an input/output devices such as a monitor and keyboard, a tablet or a smartphone. However, electronic systems only make it easier for existing systems to generate more unique documents, because storage is easier. Because hundreds of millions of documents can be stored electronically, no one has stopped to question the proliferation of documents. If these documents were stored as paper, the physical constraints of space would eventually lead people to find a way to limit the actual number of unique documents. Within electronic systems, the growing number of documents, makes the management and organization of these documents burdensome. This goes against the spirit of making the safety data readily available and easily accessible to everyone. Not to mention that, during an emergency, finding the relevant safety information when it is buried in a document within an ever-growing number of unique but related or similar documents may not be practical.

GHS safety data sheets, as adopted in the United States, have 16 sections, each of these 16 sections requiring input from the company creating and distributing the data sheets. Section 1 is for Chemical Product and Company Identification, including Product Identifier [WHMIS Classification], Product Use, Manufacturer's Name, Supplier's Name, Street Address, City, Province or State, Country, Postal Code, Emergency Telephone, the Date MSDS was prepared, and contact for the person who prepared it. Section 16 is optional and provides a space for other information, at the end of the safety data sheet. Section 2 contains information about hazards identification, GHS signal word, classification of the substance, hazard-determining components of labeling, label elements, hazard pictograms, hazard and precautionary statements. Section 3 contains information on the composition and information on the ingredients (components) including hazardous ingredients (specific), percentage, and CAS Number. Section 4 includes first aid measures including for contact with skin and eyes, inhalation and ingestion. Section 5 contains instructions for fire fighting, such as unsafe conditions, means of extinction and hazardous combustion products. Section 6 contains leak and spill procedures for accidental release. Section 7 contains handling and storage requirements and equipment. Section 8 contains exposure control and personal protective measures, including exposure limits, engineering controls, such as ventilation or enclosed processing. Personal protective measures may include gloves, respirator, eye protection, footwear, clothing and other. Section 9 contains physical and chemical properties of the material including: Physical State, Odor and Appearance, Odor Threshold (ppm), Specific Gravity, Vapor Density, Vapor Pressure, Evaporation Rate, Boiling Point (° C.), Freezing Point (° C.), pH and Coefficient of Water/Oil Distribution [Solubility in Water]. Section 10 contains stability and reactivity information, as well as a list of incompatible substances and any hazardous decomposition products, as a result of reactivity. Section 11 contains toxicological information including effects of acute exposure, chronic exposure, irritancy, skin sensitization, respiratory sensitization, carcinogenicity, reproductive toxicity, teratogenicity, embryotoxicity, mutagenicity, and the name of any synergistic products or effects related to toxicity. Section 12 contains information relevant to the ecology, such as for a spill or release, including aquatic toxicity. Section 13 contains waste disposal considerations. Section 14 contains any special shipping information, and Section 15 contains regulatory information required by various agencies.

None of the known systems for creating, storing or distributing Safety Data Sheets and labels solve the problem of safety data sheet content management or distribution created by the exponential increase in “products” and the ever increasing information that must be contained on safety data sheets. For example, one third party system provides 10,000 new and/or updated safety data sheets every week.

### SUMMARY

A computerized system includes a computer processor, storage media, a database or databases and programming that automates the creation, storage and distribution of material safety data sheets for products and materials used in the manufacture of those products. While the computer is known and may be a general purpose computer, the system is not merely an abstract idea. Instead, the system involves the creation of safety data sheets that meet both the spirit and the letter of safety data sheet regulations in a substantially new way, achieving a substantially new result that has nothing to do with non-automated paper safety data sheet systems. Unlike known systems, which merely automate the creating, storage and retrieval of safety data sheets using the same methods as used with older paper systems, an example of a safety data sheet creation and distributions system automates creation, revision, management and distribution of multiple “child” safety documents in a way that has never been done before. A plurality of versions of a safety data sheet for products with common elements and a plurality of trade names, item numbers, distributors and other variable data entries are created—on demand—for a company and its customers with an interface that is understandable by humans.

In one example, more than 25,000 regulatory masters may be created by a system for safety data sheet creation and distribution by dividing processing of safety data into two categories or masters. For example, the two categories are physical masters and health masters. Technical data is provided from physical masters and health data is provided from health masters from a variety of sources, for example. In one example, data for creation of safety data sheets may be categorized into more than two categories, such as six categories. For example, the six categories may be (1) physical masters, (2) health masters, (3) component masters, (4) client product masters, (5) client safety data and (6) white label safety data.

In one example of a system using these six categories, a system of creating and distributing safety data sheets starts with more than 35,000 regulatory masters created using a combination of about 3000 physical masters and about 20 health masters, for example. This simplifies known systems that start with 100 million components (or more) to create an infinite variety of safety data sheets. In this example, about 3000 physical masters and about 20 health masters could create 60,000 unique combinations (i.e. 3000×20=60,000). However, the system will only combine some of the physical masters with some of the health masters, based on rules maintained by the system. Thus, the number of distinct, relevant data sheets created using about 3000 physical masters and 20 health masters is actually more limited than the 60,000 possible, unique combinations. Instead, these create about 35,000 data sheets, for example, because some of the physical masters may not be combined with some of the health masters, according to the rules provided by the system. In one example, a plurality of health masters may be combined with one physical master.

For example, if a user selects one of the about 20 health masters available in the system, the system only allows the user to select from a subset of the 3000 physical masters. The subset includes only those physical masters, from the collection of 3000 physical masters, that can be combined with the health master selected. For example, more than one health master may be combined with a physical master, but only one physical master may be combined with health masters to create a regulatory master. In one example, a user may select a physical master first or a health master first or may enter technical data into fields that will narrow the selection down to the correct physical master and health master as technical data is entered for a composition.

In another example, a user might select one of the physical masters. Then, the system would only provide a subset of the health masters to choose from in combining the physical master with the health master.

Ultimately, an infinite number of completed safety data sheets may be produced starting from about 3000 physical masters and about 20 health masters, by adding in the other four categories, but limiting the interface of the system to start with a combination of these two categories greatly simplifies safety data sheet creation and distribution compared to known systems that start with 100 million components or more.

Each safety data sheet may have up to 16 sections, for example. Under known systems, each of these 16 sections must be addressed. However, in an example of a system for creating and distributing safety data sheets, attention is directed to only 6 categories of information.

In one example, the category of physical masters may comprise about 3000 physical masters that contain some or all of the information needed to complete Sections 2, 4, 5, 6, 7, 8, 10, 13 and 16, for example. The about 3000 physical masters cover much of the technical data needed to complete any data sheet that might be created using the system. However, in one example, some of the information contained in Sections 2, 4, 6, 7 and 8 of a data sheet is provided by 21 health masters. Thus, the about 3000 physical masters provides technical data and the 21 health masters provide most of the health related information needed on any safety data sheet created by the system. In this example, not all physical masters are compatible with all of the health masters. Instead, once a physical master is selected, the number of applicable health masters to select from may be reduced from 21 to fewer than 20, perhaps much fewer or even just one health master, for example. The system automatically assigns certain portions of the information contained in the physical master and certain portions of the data contained in the health master to each of the 16 sections of a safety data sheet. In one example, the system combines the health information and the technical information into an intermediate regulatory master, which merges the information from the physical master and the health master, prior to completing creation of a safety data sheet.

Looking at any of the six categories in one example of the system, each of these six categories may provide information to one or more of the 16 sections in a safety data sheet. For example, technical information of a physical master may be used to complete sections 2, 4, 5, 6, 7, 8, 10, 13, and 16 of a safety data sheet. Health information of a health master may be used to complete sections 2, 4, 6, 7, and 8, for example. One or more component masters may be used to add component information to sections 2, 3, 8, 11, 12 and 15 of a safety data sheet, for example. A client product master may be created by a user to supply information specific to a particular product, and this information may be added to sections 3 and 15 of a safety data sheet, for example. Information specific to a client safety data sheet may be added to a client safety data sheet master, and when selected, the information of the client safety data sheet master may be added to sections 1, 9 and 14 of the safety data sheet, for example. In one example, the system may comprise a white label safety data sheet master for safety data sheets that are distributed to others for completion with their own company information, and this master may add information to section 1, for example.

Even though technical information is provided by only about 30,000 regulatory masters, the system is not limited in the number of safety data sheets that can be created. The creation of physical masters and rules in the system on how information from the physical masters may be combined with the other 5 categories, in this example, to generate information for each of the 16 sections of a safety data sheet, greatly simplifies automated creation of safety data sheets. Also, for example, the system may generate additional combinations of physical and health masters based on rules generated by the system, based input to the database over time. The system automatically pulls from each of the six categories in this example to create and distribute safety data sheets for all of a company's products, for example, regardless of the trade name or brand given to a product. Thus, the safety data sheets created comply with both the letter and spirit of the laws, regulations and guidelines promulgated by national and international organizations.

As additional components become available, the number of physical masters and health masters don't necessarily increase, because additional component masters add only the necessary data to a few lines of safety data sheets. There is not a one to one correspondence with increasing components and increasing physical masters and health masters. Instead, most of the new components may be assigned to existing physical masters and health masters, without creating new physical masters and health masters. Thus, the system is both easier to learn and is easier to maintain from the perspective of a manufacturer or supplier. Known systems, starting with components, are constantly growing, exponentially with increases in the number of components, which is a substantial problem for storage, operation, maintenance and training for use of known systems.

In one example, a computerized system for creation of safety data sheets comprises a plurality of physical masters comprising technical information, a plurality of health masters comprising health information, rules for combining the plurality of physical masters with the plurality of health masters, rules for assigning technical information from the plurality of physical masters to a plurality of sections of a safety data sheet, and rules for assigning health information from the plurality of health masters to a plurality of sections of a safety data sheet, wherein selecting one of the plurality of physical masters limits the possible choices for selecting from the plurality of health masters. Alternatively, selecting one of the plurality of health masters limits the possible choices for selecting from the plurality of physical masters.

In one example, a user interface is provided, wherein a keyword search provides a list of possible physical masters selected from all of the physical masters in the system. Selecting one of the physical masters offered by the interface provides a list of possible health masters selected from all of the health masters, wherein the list of health masters is limited by rules contained in the system that permits only some specific combinations of physical masters and health masters or prevents some combinations of physical masters and health masters. For example, selecting one of the plurality of health masters causes the system to present a plurality of component masters. The plurality of component masters presented may be much reduced from the 100 million or more possible components that are known in the art. Therefore, the system is much simpler to use and easier to maintain that a system that starts with components to generate data for each of the sections of a safety data sheet.

In one example, a system for creating safety data sheets may be generated by examining all of the safety data sheets that a company has ever created. Outliers and erroneous safety data sheets are corrected or eliminated from consideration. Then, all of the physical technical information is separated from the health information and the component information. All of the health information that is substantially the same is grouped into a plurality of health masters, keeping track of correlations between the health masters and corresponding physical technical information. All of the physical technical information that is substantially the same is grouped into a plurality of physical masters, keeping track of correlations between the physical masters and the corresponding health information. Rules are generated, wherein selecting a physical master limits the choice of health master or vice versa. All of the component information that is substantially similar may be grouped into component masters, keeping track of correlations between components and health information and physical technical information. Then, a user interface may be created, wherein safety data sheet creation and distribution is automated. By conducting a keyword search or accessing an index, a user may select one of the physical masters. Then, only those health masters correlated with the physical master are presented to the use for selecting a health master. Then, only those component masters correlated with the selections is presented for selection of component masters. Then, a product master correlated with the physical master, health master and component master may be selected or created. The user may have the option of creating a safety data sheet with branding/company information or a white label safety data sheet without branding/company information, and the system creates and distributes the safety data sheet, for example. In one example, a decision tree is created for selecting a particular physical master and a particular health master. For example, yes or no questions may be asked or check boxes, drop down lists or the like may be used for selecting masters. More details are provided in the examples in the detailed description, and it will become apparent how to create a decision tree or other user interface by the examples provided.

A system for creating and managing safety data sheets, comprises a computer server; a data storage media comprising a database accessible by the computer server; a display device coupled in a network relation with the server; and a program that couples the computer server, the data storage device, the database, and the display device, such that the system automates creation, storage and distribution of material safety data sheets for compositions using a query system for identifying one particular regulatory master using questions about the physical properties of the composition and the effect of the composition on health, prior to identifying any components of the composition, wherein the regulatory master selected is independent of the components of the composition. One or more component masters may be created by entering data about the components of the composition, after the data for the regulatory master is selected by selecting a health master and a physical master. For example, the system combines known information about the components and the regulatory master to create a client safety data sheet.

In one example, the system starts with more than 35,000 regulatory masters created using a combination of about 3000 physical masters and about 20 health masters. Herein, “about” as used in this context means plus or minus five percent. Thus, about 3000 means 3000 plus or minus 150, and about 20 means 20 plus or minus 1. Not all combinations of physical master and health master make sense; therefore, achieving 35,000 regulatory masters from this small sample of physical masters and health masters is nonobvious.

In one example, the system uses queries to select one health master, and the selection of the health master limits access to a subset of possible physical masters, selectable by one or more additional questions about the physical properties of the composition. For example, a user selects one of about 20 health masters available in the system. Alternatively, the system uses an interface to select one physical master, prior to selecting a health master based on questions about effects of the composition on health. For example, the regulatory master may be selected by selecting a particular physical master comprising technical information required for completing sections 2, 4, 5, 6, 7, 8, 10, 13 and 16 of a safety data sheet. The regulatory master may be selected by selecting a particular physical master comprising technical data about the composition, but data for sections 2, 4, 6, 7 and 8 of the safety data sheet is provided by selecting a health master, based on technical information related to health effects of the composition. To complete a safety data sheet, one or more component masters may be added based on information about components comprising the composition.

The one or more component masters may comprise data extracted from one or more safety data sheets stored in the database of the system. For example, a database may be a single database or a distributed database comprising a plurality of databases to which the system has access, such as via a network or the Internet. This database may be maintained by the system. For example, confidential supplier data used in creating the one or more safety data sheets is protected from disclosure to a user of the safety data sheets. A client product master may be created using data supplied by a supplier by a user that does not have access to the data, and the client product master may be created by the system using the data supplied by the supplier to supply information specific to a particular product incorporating some concentration of a product supplied by the supplier. The client product master may add information to sections 3 and 15 of the safety data sheet.

### BRIEF DESCRIPTION OF THE DRAWINGS

The following drawings are illustrative examples and do not further limit any claims that may eventually issue.

FIG. 1 illustrates a schematic example of a system for creating a safety data sheet.

FIG. 2 illustrates schematically how the system creates a safety data sheet using the information from a plurality of categories or master sheets as illustrated in the example of FIG. 1.

FIG. 3 illustrates schematically a flow diagram of examples of a process for creating a safety data sheet.

FIG. 4 illustrates an example of a decision tree for selecting a master.

FIG. 5 illustrates an example of data extracted from a client safety data sheet for input as a component master.

FIG. 6 illustrates an example of a server system for operating the system.

When the same reference characters are used, these labels refer to similar parts in the examples illustrated in the drawings.

### DETAILED DESCRIPTION

To clarify labeling in drawings, labels referring to information destined for a particular section may be shown in parenthesis ( ) within the following text.

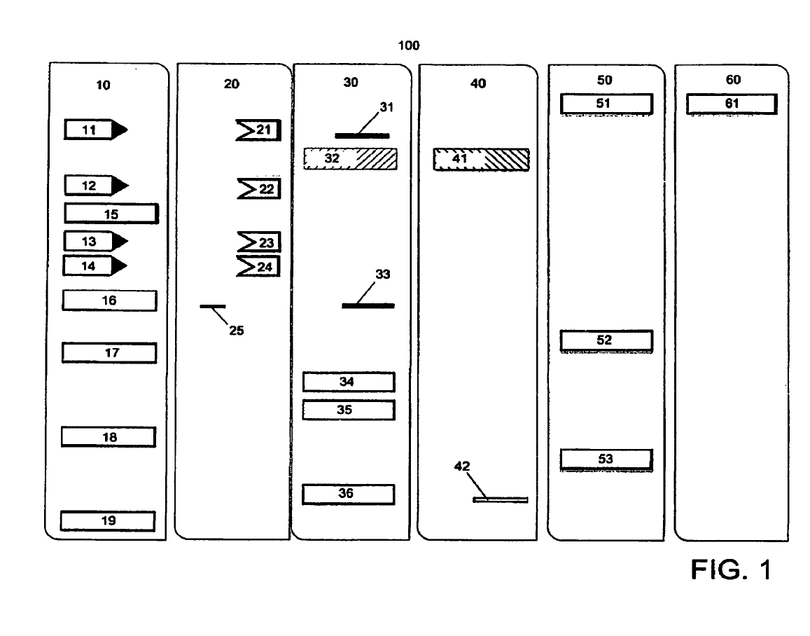

In FIG. 1, an example of a system for creating a safety data sheet comprises six categories 10, 20, 30, 40, 50, 60 of information that is combined and arranged into 16 sections of a safety data sheet. For example, a physical master 10 may be selected from a database of 3000 or more physical masters that are stored in a database accessible by the system for creating a safety data sheet. Instead of creating safety data sheets from components, which can include up to 100 million different components, every safety data sheet can be created starting with one of the available physical masters 10 from the database. Each physical master 10 comprises technical information that may be added to sections 2, 4, 5, 6, 7, 8, 10, 13 and 16 of a safety data sheet, for example.

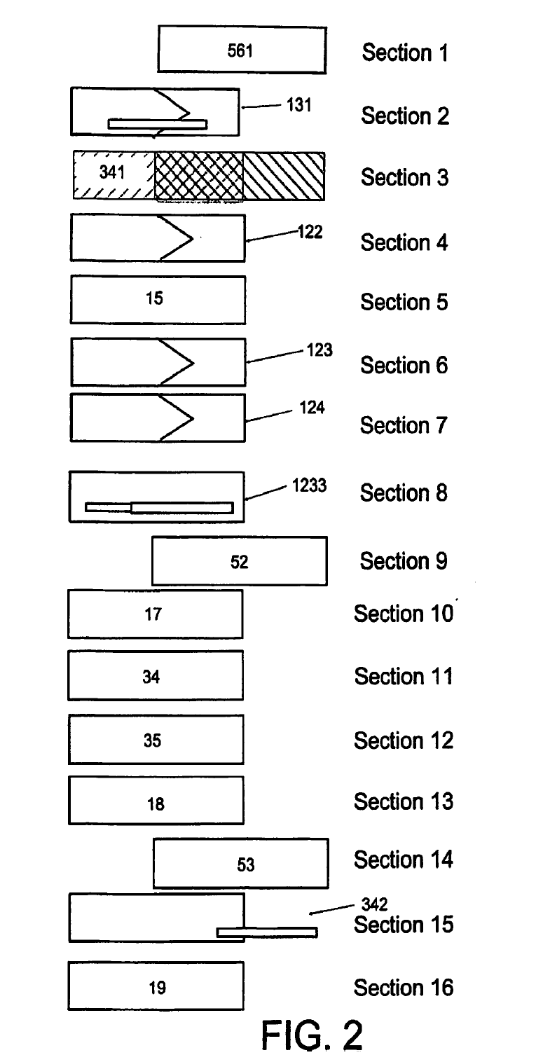

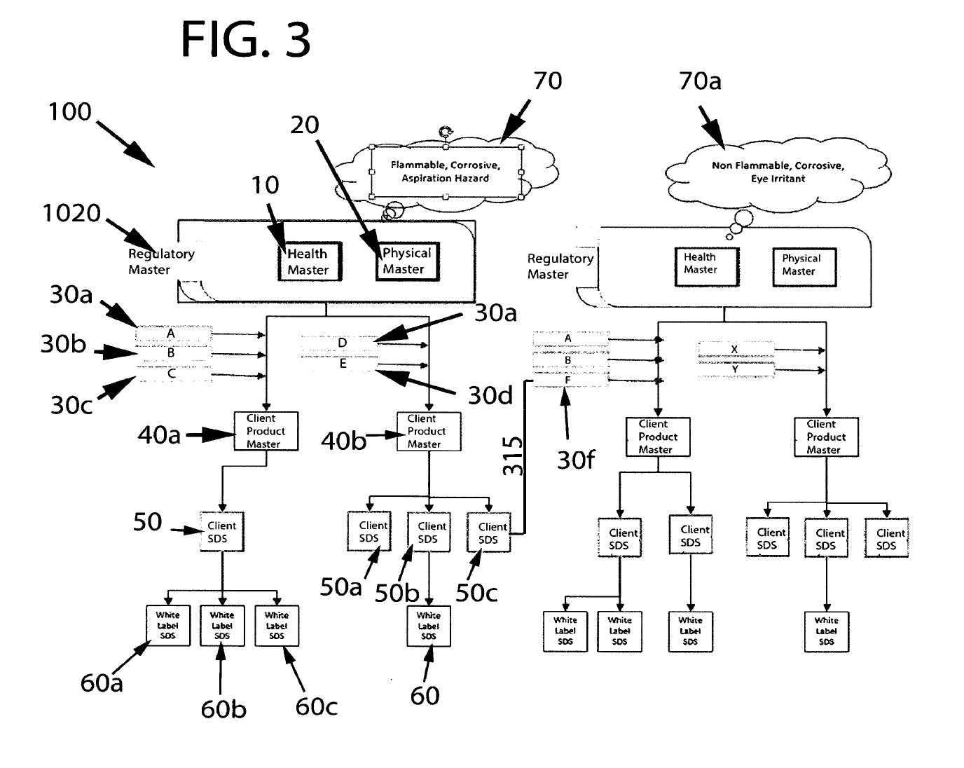

FIG. 2 illustrates how some of the information in some of the sections of a safety data sheet are combined with information from a physical master 10 and a health master 20 to complete a regulatory master 1020. The regulatory master 1020 is illustrated in FIG. 3, for example. For example, certain sections of a safety data sheet require both physico-chemical and health-biological information.

For example, section 2 (131), as illustrated in FIG. 2, may comprise hazards identification information from the physical master and information from a health master. In addition, the system may pull information 31 from one or more component masters 30 to complete the hazards identification information 131 of Section 2, as illustrated in FIG. 2. Each of the six categories 10, 20, 30, 40, 50, 60 may provide data to one or more of the sections of a safety data sheet. For example, physical master 10 provides some common technical information 11-19 relating to the material. Health master 20 provides health and health hazard information 21-25. One or more component masters 30 provide information specific to selected components of a material 31-36. Client product master 40 provides some information about the product that is specific to the particular product 41-42. Client safety data sheet 50 provides information related to a particular client 51-53, and white label safety data sheet provides information for section 1 (61) of a safety data sheet without specific client data.

FIG. 2 shows an example of how the data is combined in a safety data sheet system 100. For example, some of the information 11 in the physical master 10 is combined with information 21 from the health master 20 and information 31 from the component master 30 to create section 2 (131) in the safety data sheet. Section 3 (341) comprises information 32 from the component master 30 and information 41 from the client product master 40. For example, the information 32 from the component master 30 may be merged with the information 41 from the client product master 40, with the resulting section 3 (341) comprising a mixture. For example, various fields entered in the component master 30 may be intermixed or merged with fields entered in the client product master 40 to create the result 341. Likewise, a field 33 from the component master 30 and a field 25 from the health master 20 may be merged with information 16 from the physical master 10 to create section 8 (1233). In the example of section 15 (342) in FIG. 2, some of the fields 42 of the client product master 40 may be merged with the information 36 of the component master 30, while some may be appended in creating Section 15.

In one example, a system 100 combines a physical master and a health master into an intermediate regulatory master, as illustrated in FIG. 3, for example. Alternatively, no intermediate regulatory master may be made. Instead, the system 100 may merge information without generating a regulatory master. If a regulatory master is created, then the regulatory master 1020 may be stored in the system and may be used to create a plurality of safety data sheets 50, 50a, 50b, 50c, 60, 60a, 60b, 60c, for example. After the physical master 10 and health master 20 are selected and combined into a regulator master 1020, then one or more component masters 30a, 30b, 30c, 30d may be selected. Depending on the selected component masters, a particular client product master 40a, 40b may be selected or created. As illustrated in FIG. 1, a client product master may comprise information about section 3, “Composition/Information on Ingredients,” (41) and section 15, “Regulatory Information,” (42) of a safety data sheet. In the examples of FIGS. 1-3, the component master 30 comprises some of the information 32 added to section 3 (341) and section 15 (342) of a safety data sheet. Once the component masters are selected, then a client product master may be selected and/or created. For example, the shaded boxes 40, 50, 60 may be customized or created by a client, while the other master categories 10, 20, 30 are uneditable by client (but may be edited by an administrator or the like). In this way, some customization of safety data sheets may be delegated to client side, while other information remains secure. Once a client product master 40 is selected or created, then information may be entered or retrieved for client safety data sheets. In one example, the information in the client safety data sheet 50 may be the same for a plurality of white label safety data sheets 60a, 60b, 60c. In an alternative example, there may be a plurality of plurality of client safety data sheets 50a, 50b, 50c and only one 50b may be merged used to create a safety data sheet with white label safety data sheet information 60.

For example, client safety data sheet 50 information 51, 52, 53 may comprise details of the manufacturer and/or supplier of the safety data sheet including name, address, telephone, email and emergency contact numbers, information on basic physical and chemical properties of a finished product, such as appearance, odor, pH, boiling point and the like, and transport information, such as land, rail, air and sea transport information, applicable to safety for public transport of a finished product. White label safety data sheet 60 information 61 may comprise local emergency contact information or the like. Client product master 40 information 41, 42 may identify and describe the product and any regulatory information specific to the product that is not contained in the component masters 30.

For example, a physical master 10 may be created comprising technical information relevant to section 2 (11), section 4 (12), section 5 (15), section 6 (13), section 7 (14), section 8 (16), section 10 (17), section 13 (18) and section 16 (19), as illustrated in FIG. 1, and may be stored in a database accessible to the system 100. The information provided by the physical master for sections 2 (11), 4 (12), 6 (13), 7 (14) and 8 (16) may be supplemented by information provided by other masters in order to complete a safety data sheet. For example, a health master may be selected that provides health information to sections 2 (21), 4 (22), 6 (23), 7 (24) and 8 (25). When the information from a physical master and a health master are combined, a unique regulatory master 1020 may be generated by the system, as illustrated in FIG. 3, for example.

A plurality of physical masters are created in the system based on physical properties of known categories of a material or materials that share the same physical properties, if applicable. This provides technical information about materials that may be relevant to one or more materials, as some materials may share related technical information. Therefore, the system only requires tens of thousands of physical masters to be prepared with the relevant shared technical information in order to have the technical information relevant to a safety data sheet. In one example, these physical masters may be synthesized from many safety data sheets by separating out health information from other technical information in those sections where technical information is found. The health information may likewise be synthesized from the health information separated out by this process. Component information may be synthesized by separating out component information, and so on, until what is left are the physical properties applicable to the physical masters 10.

For example, a particular physical master may be selected by querying 70 the system, as illustrated in FIG. 3. For example, a query 70 may comprise “flammable, corrosive, aspiration hazard” or “nonflammable, corrosive, eye irritant” and one or a subset of all of the physical masters would be indicated as candidates for the particular physical master. In one system, a user interface provides checkboxes, buttons or drop down lists for formulating a specific query. In another system, a user interface may be speech to text or entry of keywords or text. Regardless of the interface used for selecting a particular physical master, once the physical master is selected, then a subset of health masters will be available to be selected. A subset of health masters may be all of the health masters, if all of the health masters are applicable to a particular physical master. However, in nearly every instance, selection of a physical master means that the subset of applicable health masters is much reduced from the total number of health masters stored in a database available to the system. Indeed, in some cases, only a single health master may be available if a particular physical master is selected. In other examples a plurality of health masters may be available to be selected.

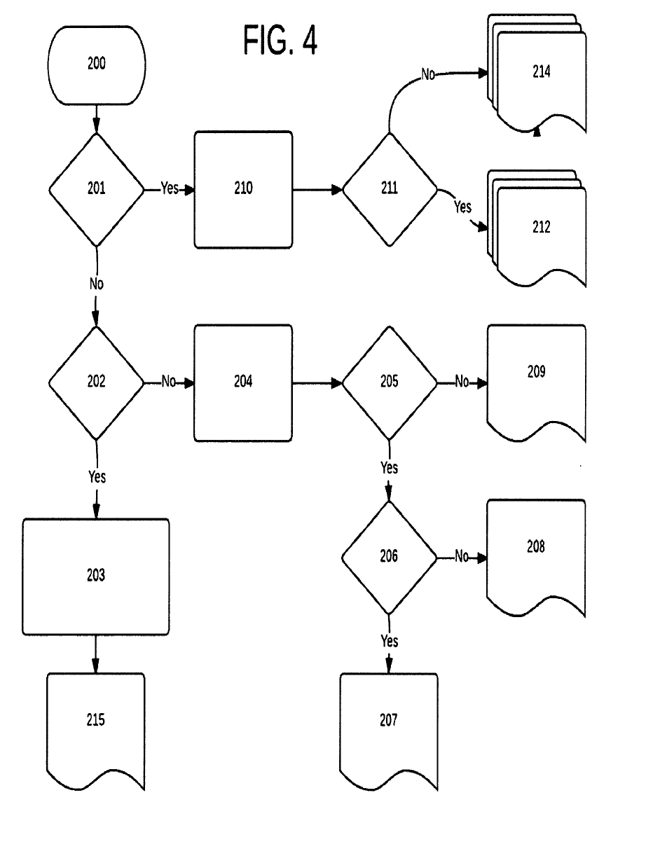

FIG. 4 illustrates a decision tree for structuring a query 70. For example, a safety data sheet may need to be created for a new formulation of a product 200. A question 201 may be asked that can be answered yes or no, such as “is the flashpoint above 200 degrees?”. If yes, then the product is classified as not flammable 210. Then, another question 211 is presented: “is the pH greater than 12.5 or less than 2.0?”. If no, then the product is not corrosive and not flammable, and one of the not corrosive/not flammable physical masters 214 could be selected. Of course, by asking additional questions, a specific one of the physical masters 214 master may be selected, eventually, each physical master serving a specific purpose for a product with properties fitting a specific regulatory profile. Alternatively, if the answer to the first question 201 was no, then the product would be classified as either flammable or combustible. Therefore, a second question must be asked: “is the flashpoint below 100 degrees?”. If yes, then the new formulation is flammable 203, and one of the flammable physical masters 215 should be used. If no, then the new formulation is combustible 204, and another question 205 is presented: “is the kinematic viscosity less than 20 mm squared per second at 40 degrees?”. If yes, then another question is asked: “are any of the components an aspiration hazard?”. If yes, then combustible, component aspiration hazard physical master 207 should be used. Alternatively, if no, then a combustible hazard physical master 207 should be used. By using a decision tree arrangement, whenever a selection between two or more masters is required, the system will select a specific, master from a database of masters, such as masters created to provide the technical characteristics and hazard warnings required for sections 2, 4, 5, 6, 7, 8, 10, 13 and 16.

In one example, after a physical master 10 is selected using a decision tree, then a health master is selected from health masters 20 compatible with the physical master 10, based on another decision tree. After the health master 20 is selected, then a regulatory master is created 1020. An interface may provide for decision tree, check boxes or other ways of selecting or creating the remaining categories 30, 40, 50, 60, until a safety data sheet is created. Once created, a safety data sheet may be distributed by the system 100 to anyone needing access to the safety data sheet.

There are problems with known systems for generating safety data sheets. For example, safety data sheets that use components require knowledge of all components added to a final composition including a concentration of components within the final composition. Otherwise, the safety data sheet may omit required information about components that meet a threshold requirement. However, suppliers may not know exact concentrations or may protect component information as a trade secret. In one example, the system provides for a supplier to enter information about a component or components into a database entry for a product supplied to a third party that may include a range of concentrations of components of the product. For example, the presence of a concentration or range of concentration of a particular component in the composition may be protected from disclosure to the third party. This allows the system to determine if a mixture of products, including some concentration the supplier's product, may have a concentration of a particular component, such that the concentration of the particular component meets a threshold for reporting on a safety data sheet, even if the concentration of the particular component comes from more than one product or supplier. For example, a particular component, such as a corrosive component, may be contained in more than one product combined into a final composition by a manufacturer. The system determines the concentration in the final composition by adding the amounts or concentrations of each component from the more than one product, such as by using the maximum concentration from a range of concentration provided by the supplier or suppliers of the component products

In one example, the safety data sheet for an intermediate product created by a manufacture is used as a component master in creating a subsequent safety data sheet for a subsequent product containing a concentration of the intermediate product within the subsequent product. In this example, the information needed for a component master is extracted, automatically, from the safety data sheet of the intermediate product for determining the component information reported in the subsequent safety data sheet of the subsequent product. For example, the composition of this subsequent product may be protected from disclosure to third parties and may comprise a composition containing more than one components, each of the more than one component having compositions protected from disclosure to third parties, including even the manufacturer of the intermediate product or products. Each of these may have been an intermediate product, and so on. Thus, the system protects the confidentiality of trade secrets of suppliers of products, while permitting users of the system to create compliant safety data sheets that report components that exceed a given threshold concentration.

For example, a combination of components in a composition may result in a product that contains a corrosive in concentrations that is required to be reported on its safety data sheet. Similarly, other data sheet requirements may be influenced by the mixture of components in a composition, when some of the components are mixtures of other components. As shown in FIG. 3, selection of a health master 10 and physical master 20 may be directed by a query 70, 70a, resulting in selection of differing information in a regulatory master 1020. For example, sections 2, 4, 5, 6, 7, 8, 10, 13 and 16 of any particular safety data sheet are the same for the same regulatory master 1020, while different regulatory masters may have different information in these sections. By adding information from different component masters 30a, 30b, 30c, 30d, 30f, differences in ingredients and differences in concentration ranges of ingredients are accommodated in a plurality of client product masters 40a, 40b. Sections 3, 9, 11, 12, 14 and 15 are influenced by the particular component masters selected. In one example, only sections 3, 9 and 14 may be edited. Alternatively, the system may permit portions of sections 11, 13 and 15 to be edited, also. For example, the system may authorize only those individuals at an appropriate level or with proper access to edit portions of sections 11, 13 and 15. A plurality of client safety data sheets 50, 50a, 50b, 50c may be created by altering the formulation, while keeping the component ingredient ranges the same, for example. For example, an exact formula within a range may be specified for a particular formulation, to meet client needs. Thus, there is no difference within sections 2-16 of a client safety data sheet, but the specific formula within the client safety data sheet may be different (within the specified range). Thus, selection of a particular client safety data sheet 50c as an input to a component master may influence the resulting client product master, even if the supplier does not provide access to the ingredients and/or formulation to its customer. This overcomes a serious shortcoming of known systems, which either require disclosure of trade secrets to customers or have the potential of putting the customers in jeopardy for non-compliance with regulatory disclosures. By a technical solution for both protecting supplier trade secrets and providing for customer compliance, the system solves a dilemma faced by suppliers and their customers.

In one example, safety data sheets are identified as either pure substances or compositions of one or more pure substances. A pure substance is not 100% pure. Instead, a “pure substance” is defined, herein, as essentially a single component, as identified by a CAS number, and not a mixture, allowing for normal impurities acceptable in the industry as known in the art for any particular CAS registry number. A CAS number or CAS registry number is a unique numerical identifier assigned by Chemical Abstracts Service to every chemical substance described in the open scientific literature. This includes organic and inorganic compounds, minerals, isotopes, alloys and materials, identifying more than 102 million organic and inorganic substances and 66 million protein and DNA sequences. The registry is updated daily with approximately 15,000 additional new substances. In one example, a client safety data sheet 50c for a composition of pure substances and other compositions may be utilized as component master 30a by the client, as illustrated in FIG. 3 by a line 315 drawn from client SDS 50c to Component Master “F” 30f that is used to extract information for an intermediate composition used as a component in a product utilizing the same or a different health master and/or physical master. In the example illustrated in FIG. 3, the health master and physical master are different, showing selection criteria 70a for a non-flammable, corrosive, eye irritant health/physical master combination.

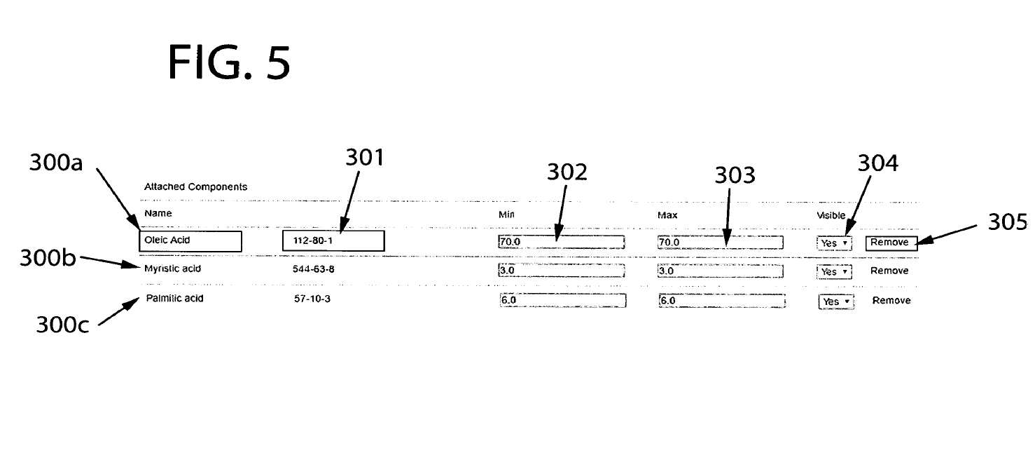

For example, FIG. 5 illustrates data entered into a database for components 300a, 300b, 300c of the composition of client safety data sheet 50c. Some of the data that may be extracted from the database for the components are the component name 300a, an identifying numbers 301, such as a CAS number for each pure substance or another identifying number, a composition range from minimum concentration 302 to maximum concentration 303, an indicator 304 (or “Protection Indicator”) for whether a component may be disclosed to a customer, and a remove toggle 305 for removing a particular component from the list of components. For example, a particular component may be removed by selecting the “Removal Toggle” if the component is lost during processing of a composition, such as by chemical reaction, purification, rendering, or the like, or if the component is not required to be listed for any other reason. A resulting safety data sheet of a composition may contain required information or warning about components, without disclosing, unnecessarily, those components of a composition that are protected from public disclosure by the supplier of the product covered by the safety data sheet 50c.

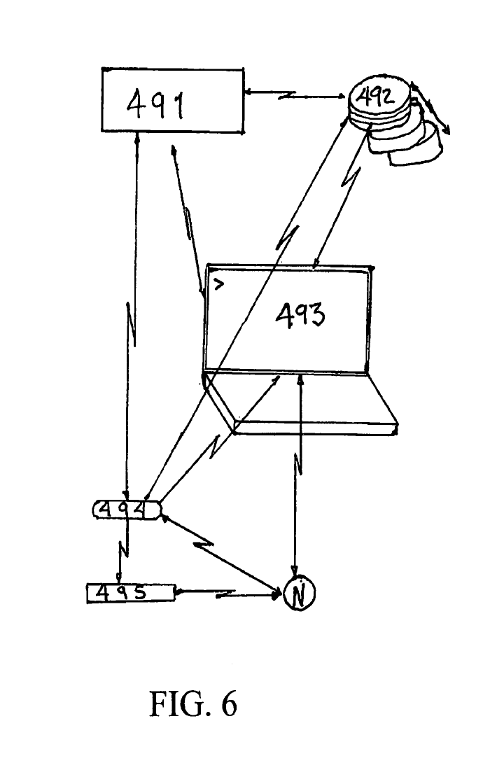

In FIG. 6, an example of a server system is graphically illustrated showing a server 491, a plurality of storage media 492, which may be discrete or distributed, a display 493, which may be attached to a computer or a stand-alone terminal, for example, a WAN/Router 494, and another device/server for interfacing to the Internet N.

This detailed description provides examples including features and elements of the claims for the purpose of enabling a person having ordinary skill in the art to make and use the inventions recited in the claims. However, these examples are not intended to limit the scope of the claims, directly. Instead, the examples provide features and elements of the claims that, having been disclosed in these descriptions, claims and drawings, may be altered and combined in ways that are known in the art.

1. A system for creating and managing safety data sheets, comprising:
a computer server;
a data storage media comprising a database accessible by the computer server;
a display device coupled in a network relation with the server; and
a program that couples the computer server, the data storage device, the database, and the display device, such that the system automates creation, storage and distribution of material safety data sheets for compositions using a query system for identifying one particular regulatory master using questions about the physical properties of the composition and the effect of the composition on health, prior to identifying any components of the composition, wherein the regulatory master selected is independent of the components of the composition.

2. The system of claim 1, wherein a component masters is created by entering the components of the composition, and the system combines known information about the components and the regulatory master to create a client safety data sheet.

3. The system of claim 2, wherein the system starts with more than 35,000 regulatory masters created using a combination of about 3000 physical masters and about 20 health masters.

4. The system of claim 2, wherein the system uses queries to select one health master, and the selection of the health master limits access to a subset of possible physical masters, selectable by one or more additional questions about the physical properties of the composition.

5. The system of claim 4, wherein the user selects one of about 20 health masters available in the system.

6. The system of claim 2, wherein the system uses an interface to select one physical master, prior to selecting a health master based on questions about effects of the composition on health.

7. The system of claim 1, wherein the regulatory master is selected by selecting a particular physical master comprising at least some of the information required for completing sections 2, 4, 5, 6, 7, 8, 10, 13 and 16 of a safety data sheet.

8. The system of claim 1, wherein the regulatory master is selected by selecting a particular physical master comprising technical data about the physical properties of the composition, and at least some of the data for sections 2, 4, 6, 7 and 8 of the safety data sheet is provided by selecting one or more health masters, based on information related to health effects of the composition.

9. The system of claim 8, wherein one or more component masters are added based on information about components comprising the composition.

10. The system of claim 9, wherein the one or more component masters comprises data extracted from one or more safety data sheets maintained by the system.

11. The system of claim 10, wherein supplier data used in creating the one or more safety data sheets is protected from disclosure to a user of the safety data sheets.

12. The system of claim 11, wherein a client product master may be created by a user to supply information specific to a particular product.

13. The system of claim 12, wherein the client product master adds information to sections 3 and 15 of the safety data sheet.
